(19) United States
(12) Patent Application Publication
(10) Pub. No.: US 2007/0035885 A1
(43) Pub. Date: Feb. 15, 2007

(54) Perpendicular magnetic recording head and method of manufacturing the same

(75) Inventors: Young-hun Im, Suwon-si (KR); Yong-su Kim, Seoul (KR); No-yeol Park, Seongnam-si (KR); Hoon-sang Oh, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/503,297

(22) Filed: Aug. 14, 2006

(30) Foreign Application Priority Data
Aug. 12, 2005 (KR) 10-2005-0074502

(51) Int. Cl. G11B 5/33

(52) U.S. Cl. 360/317; 360/126

(57) ABSTRACT

A perpendicular magnetic head for recording a perpendicular magnetic recording medium is provided. The perpendicular magnetic head includes a main pole; a return pole, which has at least an end separated from the main pole; and a plurality of shields that surround the main pole and have a split structure.

### CROSS-REFERENCE TO RELATED PATENT APPLICATION

This application claims priority from Korean Patent Application No. 10-2005-0074502, filed on Aug. 12, 2005 in the Korean Intellectual Property Office, the disclosure of which is incorporated herein in its entirety by reference.

### BACKGROUND OF THE INVENTION

1. Field of the Invention

Apparatuses consistent with the present invention relate to a perpendicular magnetic recording head, and more particularly, to a perpendicular magnetic recording head in which shields in a split structure are formed around a main pole of the perpendicular magnetic head to minimize the influence of the magnetic field of the perpendicular magnetic head on a track other than the track of the perpendicular magnetic medium to be recorded.

2. Description of the Related Art

With the advent of the Information Age, the amount of information that a person or organization deals with has significantly increased. For example, many users employ computers having high data processing speed and large information storage capacity to access the Internet and obtain various pieces of information. Central Processing Unit (CPU) chips and computer peripheral units have been developed to enhance the computer data processing speed, and various types of high density information storage media like hard disks are being researched to enhance the data storage of computers.

Recently, various types of recording media have been introduced. However, most of the recording media use a magnetic layer as a data recording layer. Data recording for magnetic recording media can be classified into longitudinal magnetic recording and perpendicular magnetic recording.

In the longitudinal magnetic recording, data is recorded using the parallel alignment of the magnetization of the magnetic layer on a surface of the magnetic layer. In the perpendicular magnetic recording, data is recorded using the perpendicular alignment of the magnetic layer on a surface of the magnetic layer. From the perspective of data recording density, the perpendicular magnetic recording is more advantageous than the longitudinal magnetic recording.

FIG. 1A illustrates a conventional perpendicular magnetic recording apparatus. Referring to FIG. 1A, the conventional magnetic recording apparatus includes a recording medium 10, a recording head 100 for recording data on the recording medium 10, and a reading head 110 for reading the data from the recording medium 10.

The recording head 100 includes a main pole P1, a return pole P2, and a coil C. The main pole P1 and the return pole P2 may be formed of a magnetic material, for example, NiFe, and the saturation magnetic speed Bs of the main pole P1 and the return pole P2 may be varied based on different composition ratios thereof. The main pole P1 and the return pole P2 are directly used to record data on a recording layer 13 of the perpendicular magnetic recording medium 10, which also contains a base layer 11 and a soft magnetic material layer 12. A sub yoke 101 may be further included at a side of the main pole P1 to concentrate the magnetic field generated in the main pole P1 while recording data in a selected area of the perpendicular magnetic recording medium 10. The coil C surrounds the main pole P1, and generates a magnetic field so that the main pole P1 can record data onto the recording medium 10.

The reading head 110 includes first and second magnetic shield layers S1 and S2 and a data reading magnetic sensor 111 formed between the first and second magnetic shield layers S1 and S2. While reading data from a specified region of a selected track, the first and second shield layers S1 and S2 shield the magnetic field generated by the magnetic elements around the above area from reaching the specified region. The data reading magnetic sensor 111 may be a giant magnetoresistive (GMR) or a tunnel magnetoresistive (TMR) structure.

In FIG. 1A, an x-axis denotes the direction in which the recording medium 10 proceeds and is generally referred to as the down track direction of the recording layer 13. A y-axis is perpendicular to the down track direction, and is generally referred to as the cross-track direction.

FIG. 1B illustrates an air bearing surface (ABS) of the main pole P1 and the return pole P2 in a portion A of the conventional perpendicular magnetic recording apparatus in FIG. 1A. The ABS denotes a surface of the recording head 100 facing the recording layer 13. Referring to FIG. 1B, the magnetic field applied by the main pole P1 magnetizes the magnetic domain of the recording layer 13 to record data. However, the magnetic field may affect the magnetization of the magnetic domain of other adjacent tracks.

FIG. 2 is a schematic view of a perpendicular magnetic head disclosed in U.S. Pat. No. 6,728,065. Referring to FIG. 2, circular side shields 22a and 22b are formed on both sides of a recording pole 21 of a magnetic recording medium 20 to reduce the influence of the magnetic field generated from the sides of the recording pole 21 during data recording. Thus, the side shields 22a and 22b are presently employed to control the path of the magnetic field in the field of magnetic heads.

### SUMMARY OF THE INVENTION

The present invention provides a perpendicular magnetic recording head including an optimized shield structure that minimizes the influence of the magnetic field applied from the perpendicular magnetic recording head to a magnetic domain of adjacent tracks, and a method of manufacturing the same.

According to an aspect of the present invention, there is provided a perpendicular magnetic head for recording a perpendicular magnetic recording medium including a recording layer, the perpendicular magnetic head moving in a direction of a track above the recording layer, recording information on the recording layer, and reading the information from the recording layer, the perpendicular magnetic head including: a main pole; a return pole, an end of which is separated from the main pole; and a plurality of shields that surround the main pole and have a split structure.

The shields may be disposed at both sides of the main pole in the track direction and on the opposite side of the return pole of the main pole.

The shields may be formed of NiFe.

A distance between the shields on both sides of the main pole may be 500 nm or less.

A distance between the main pole and the shields may be greater than a distance between the main pole and the return pole.

An insulating layer may be formed between the main pole, the return pole, and the shields.

The insulating layer may be formed of Al₂O₃ or SiO₂.

A surface of the shields adjacent to the main pole may be an oval.

According to another aspect of the present invention, there is provided a method of manufacturing a perpendicular magnetic head for recording a perpendicular magnetic recording medium, including: (a) forming a first shield layer, a first insulating layer, and a second shield layer; (b) etching a portion of the second shield layer, and sequentially forming a second insulating layer and a third shield layer on the remaining second shield layer and the first insulating layer; (c) forming a main pole by etching the third shield layer and sequentially forming a third insulating layer and a fourth shield layer; and (d) forming a fourth insulating layer by etching a portion corresponding to the main pole of the fourth shield layer, and forming a return pole on the fourth insulating layer.

The first, second, third and fourth shield layers may be formed of NiFe.

According to the present invention, operation (b) may include: forming photoresist layers on the second shield layer at an interval of 500 nm or less; and exposing the first insulating layer by etching the second shield layer exposed between the photoresist layers.

According to the present invention, operation (c) may include: forming patterned photoresist layers on the third shield layers; forming the main pole by etching the third shield layer exposed by the photoresist layer; and forming the third insulating layer by coating an insulating layer between the main pole and the third shield layer and on the main pole.

The present invention may further include planarizing the second, third, and fourth insulating layers using a chemical-mechanical planarizing (CMP) process.

### BRIEF DESCRIPTION OF THE DRAWINGS

The above and other aspects of the present invention will become more apparent by describing in detail exemplary embodiments thereof with reference to the attached drawings in which:

FIG. 1A is a cross-sectional view of a conventional perpendicular magnetic head;

FIG. 1B illustrates a portion A of the perpendicular magnetic head of FIG. 1A viewed from an air bearing surface (ABS);

FIG. 2 illustrates a conventional perpendicular magnetic head disclosed in U.S. Pat. No. 6,728,065;

FIG. 3 illustrates a perpendicular magnetic head viewed from the ABS according to an exemplary embodiment of the present invention;

FIG. 4A is cross-sectional a perspective view of a perpendicular magnetic head according to an exemplary embodiment of the present invention;

FIG. 4B illustrates a perpendicular magnetic head including a cylindrical return pole around a main pole according to an exemplary embodiment of the present invention;

FIG. 5 illustrates the measurement of a recording field in the down track direction of a magnetic medium of the perpendicular magnetic head illustrated in FIGS. 4A and 1A;

FIG. 6 illustrates the calculation of a recording field in the cross track direction of a magnetic medium of the perpendicular magnetic head illustrated in FIGS. 4A and 1A;

FIG. 7A is a graph showing a recording field of the perpendicular magnetic head illustrated in FIGS. 4A and 4B at 280 through 480 nm in the cross track direction;

FIG. 7B is a graph illustrating the difference between the two values illustrated in FIG. 7A at 360 through 480 nm in the cross track direction of the magnetic medium;

FIG. 8A illustrates the field distribution of the conventional perpendicular magnetic head, and FIG. 8B illustrates the field distribution of the perpendicular magnetic head according to an exemplary embodiment of the present invention; and

FIGS. 9A through 9K illustrate a process of manufacturing the perpendicular magnetic recording head according to an exemplary embodiment of the present invention.

### DETAILED DESCRIPTION OF THE EXEMPLARY EMBODIMENTS

The present invention will now be described more fully with reference to the accompanying drawings, in which exemplary embodiments of the invention are shown. In the drawings, the thicknesses of layers and regions are exaggerated for clarity.

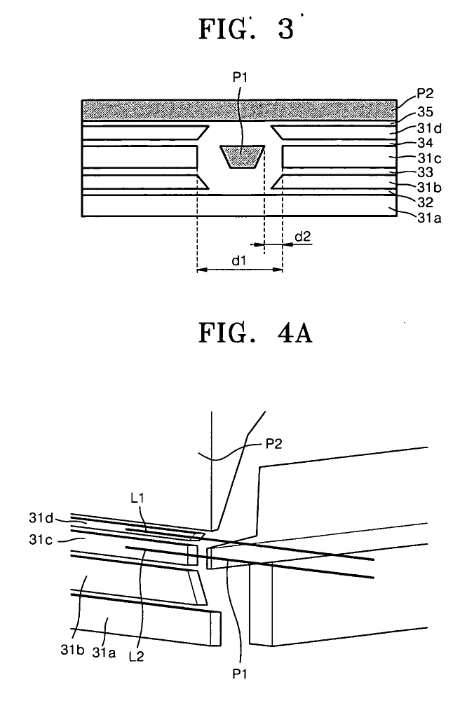

FIG. 3 illustrates a perpendicular magnetic head viewed from an air bearing surface (ABS) according to an exemplary embodiment of the present invention. Referring to FIG. 3, the perpendicular magnetic recording head includes a main pole P1, a return pole P2 spaced apart from the main pole P1, and a plurality of shields 31a, 31b, 31c, and 31d that surround the main pole P1 and have a split structure. Ends of the shields 31a, 31b, 31c, and 31d in the split structure may be circular, oval, or asymmetrical.

The shields 31a, 31b, 31c, and 31d may be formed of a magnetic material as the main pole P1 and/or the return pole P2, for example, of NiFe. A distance d1 between the shields on both sides of the main pole P1 may be less than 500 nm. A distance d2 between the main pole P1 and the shields 31a, 31b, 31c, and 31d may be greater than a distance between the main pole P1 and the return pole P2, that is, a write gap.

Insulating layers 32, 33, 34, and 35 are formed between the shields 31a, 31b, 31c, and 31d in the split structure and formed of an insulating material such as Al₂O₃.

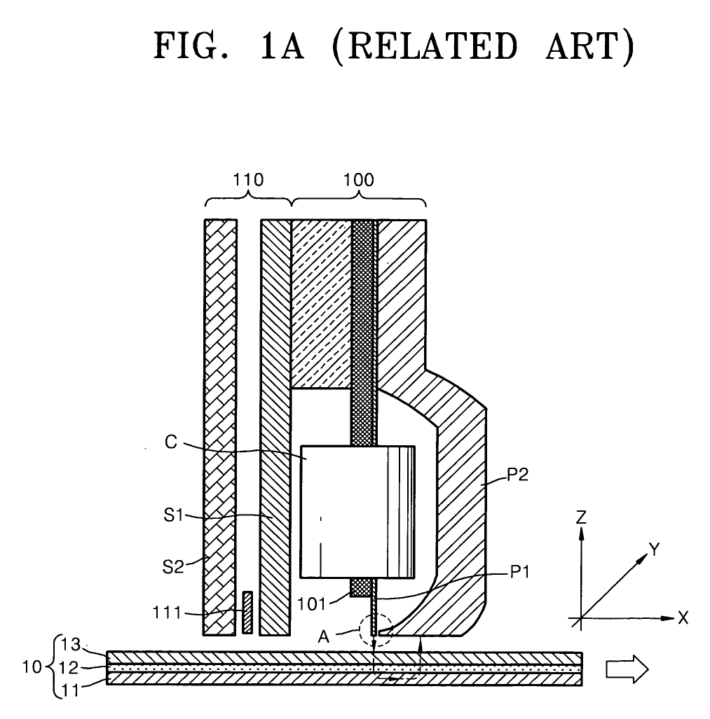

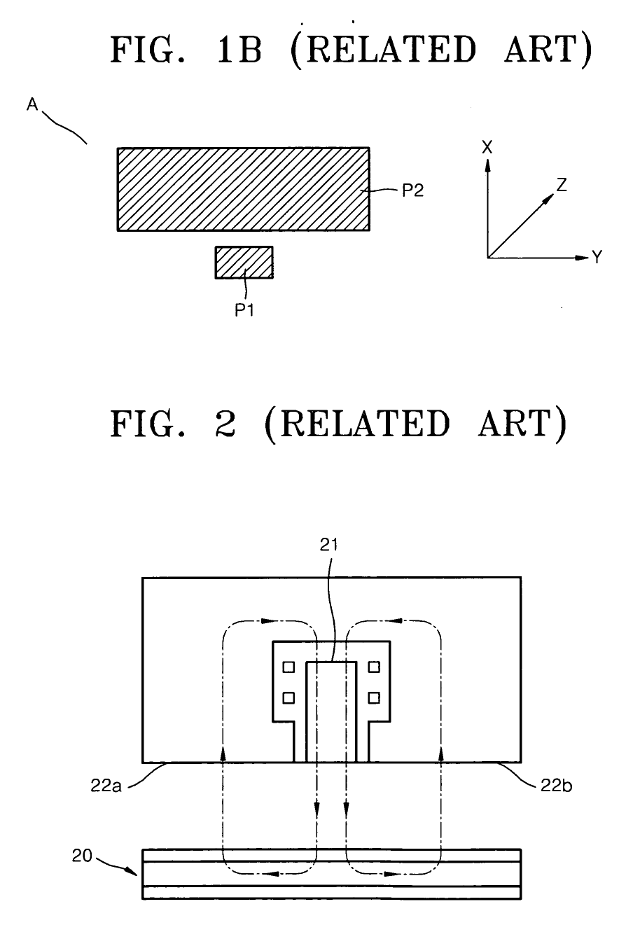

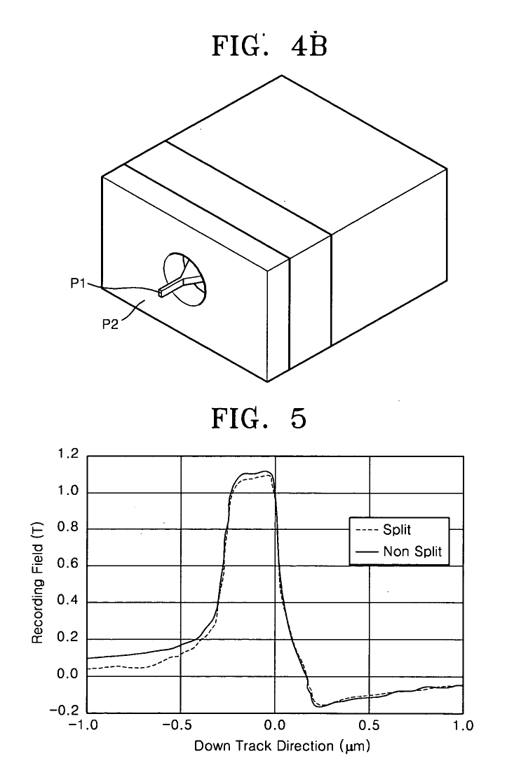

Hereinafter, the magnetic characteristic of the perpendicular magnetic head according to an exemplary embodiment of the present invention will be described with reference to the attached drawings. For this, the recording characteristic of the perpendicular magnetic head in FIG. 4A according to the present exemplary embodiment and the perpendicular magnetic head in FIG. 1A are examined.

FIG. 4A is a cross-sectional perspective view of the perpendicular magnetic head of FIG. 3 along the track direction of the main pole P1 according to an exemplary embodiment of the present invention.

Referring to FIG. 4A, shields surrounding the main pole P1 has oval ends. FIG. 4B illustrates a perpendicular magnetic head formed of a main pole P1 and a return pole P2.

FIG. 5 is a graph illustrating a recording field applied to the magnetic domain of a recording layer disposed in the down track direction by the magnetic field applied by the main pole P1 of the perpendicular magnetic heads illustrated in FIGS. 4A and 1A, that is, the strength of perpendicular elements of the magnetic fields. In FIG. 5, Split denotes the perpendicular magnetic head of FIG. 4A, and Non Split denotes the perpendicular magnetic head of FIG. 1A.

Referring to FIG. 5, there is a slight difference in the strength of the perpendicular magnetic field of the recording layer receives according to the distance in the down track direction. However, the difference in the capability or effect of the magnetic heads is not great. Accordingly, both perpendicular magnetic heads Split and Non Split show similar effects in the down track direction.

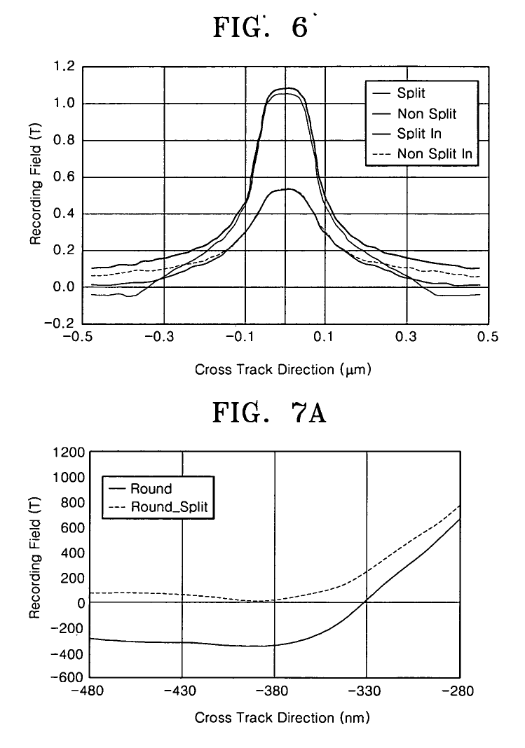

FIG. 6 illustrates the calculation of a recording field in the cross track direction of a magnetic medium of the perpendicular magnetic heads illustrated in FIGS. 4A and 1A, that is, the calculation of the strength of the perpendicular elements of the magnetic field. In FIG. 6, Split denotes a direction L1 of the perpendicular magnetic head of FIG. 4A, and Non Split denotes the perpendicular magnetic head of FIG. 1A. Split In denotes a direction L2 of the perpendicular magnetic head of FIG. 4A.

Referring to FIG. 6, when a distance in the cross track direction is between −0.1 and 0.1 μm, both recording heads show almost similar recording fields. Around 0 μm, both recording heads show almost equal values. However, in the region at −0.2 μm or less and at 0.2 μm or more, the perpendicular magnetic head of FIG. 1A having a Non Split structure has a greater recording field. These regions show the influence of the recording head on a track two to three tracks away from the recording track.

Accordingly, the distribution of the leakage field in the cross track direction of the magnetic head according to an exemplary embodiment of the present invention of FIG. 4A is effective. In detail, the recording field at 0.3 μm in the cross track direction is 1601 oersted (Oe) at Non Split, 1022 Oe at Non Split In, 596 Oe at Split, and 511 Oe at Split In.

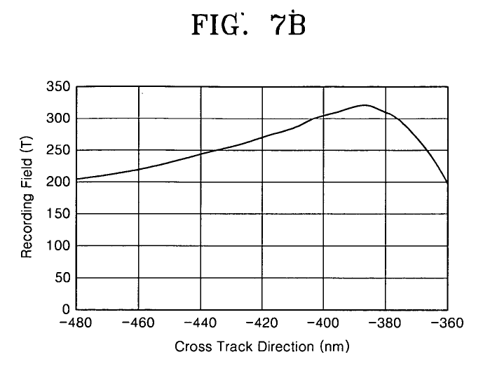

FIGS. 7A and 7B are graphs showing a recording field of the perpendicular magnetic head in the cross track direction of the perpendicular magnetic head illustrated in FIGS. 4A in which shields are not in a split structure but surround a main pole and a perpendicular magnetic head according to an exemplary embodiment of the present invention. Here, recording fields two or three tracks away from the main pole P1 in the cross track direction are measured.

Referring to FIG. 7A, the perpendicular magnetic head including round shields, which are not in a split structure, has a greater absolute value of the recording density compared to the perpendicular magnetic head (Round Split) according to the present exemplary embodiment. On the other hand, the perpendicular magnetic head according to the present exemplary embodiment has a very small absolute value of the recording field.

FIG. 7B illustrates a difference in the recording fields illustrated in FIG. 7A, which is 200 Oe at 480 nm in the cross track direction. Accordingly, the perpendicular magnetic head according to the present exemplary embodiment can effectively reduce the leakage field in the cross track direction.

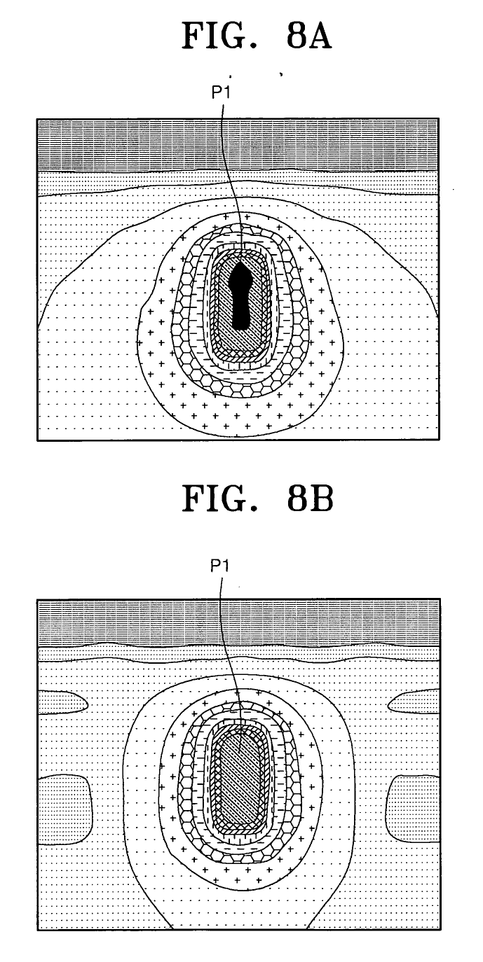

FIGS. 8A and 8B respectively show simulation results of the strength of the magnetic field applied by the main pole P1 of the perpendicular magnetic heads in the prior art and in the present exemplary embodiment. FIG. 8A illustrates the strength of the perpendicular magnetic field of a conventional single pole head. FIG. 8B illustrates the strength of the perpendicular magnetic field of the perpendicular magnetic head according to the present exemplary embodiment.

Referring to FIGS. 8A and 8B, the strength of the perpendicular magnetic field adjacent to the main pole P1 of both magnetic heads is similar; however, the difference in the strength of the magnetic field increases significantly toward the sides and to the lower portions. The perpendicular magnetic head in a split structure according to the present exemplary embodiment illustrated in FIG. 8B reduces a great amount of leakage fields in the cross track direction.

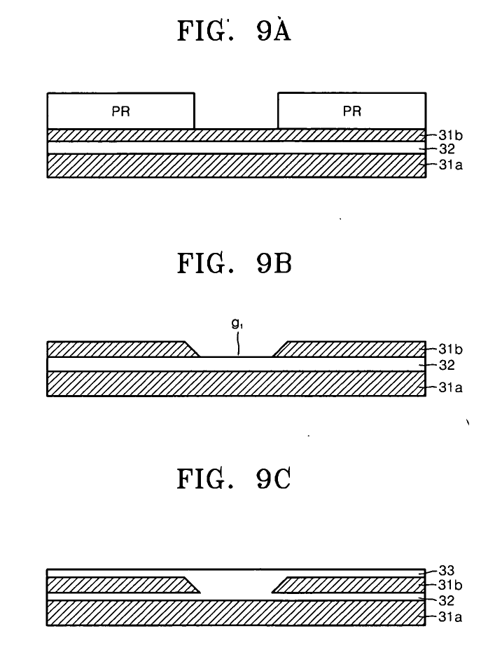

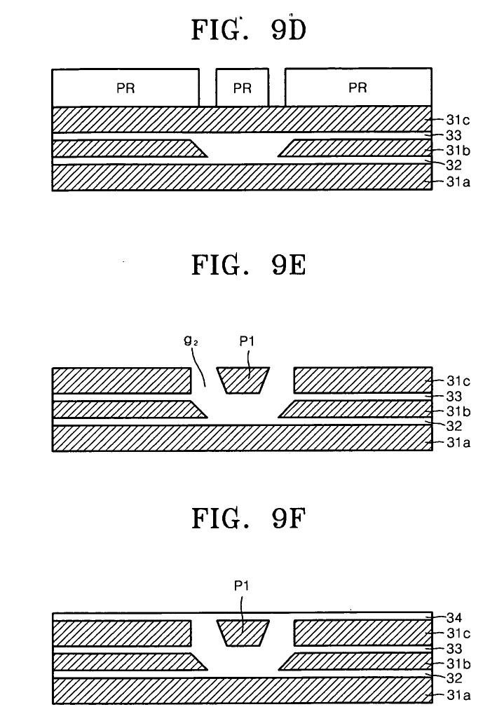

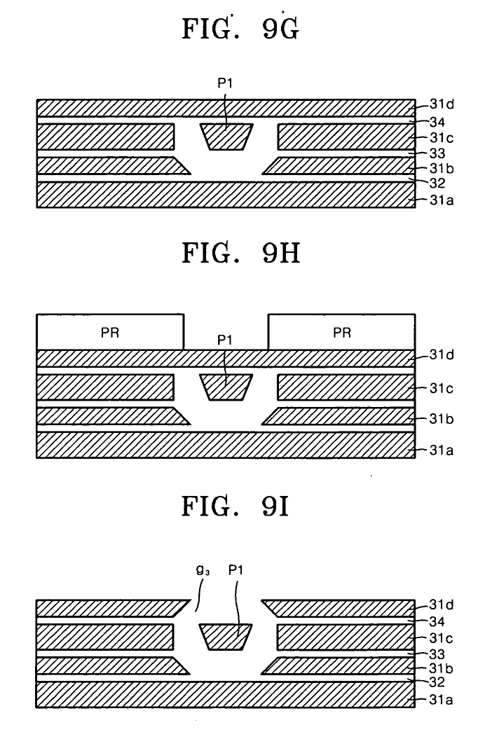

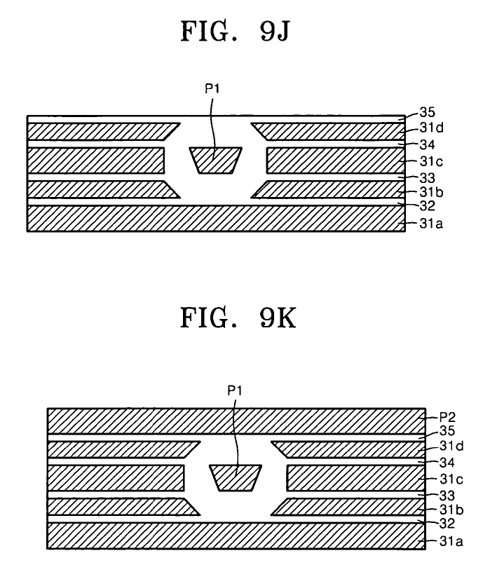

Hereinafter, a method of manufacturing the perpendicular magnetic head according to the present exemplary embodiment will be described in detail with reference to FIGS. 9A through 9K. The manufacturing processes can be easily adopted from conventional magnetic head manufacturing processes and general semiconductor device manufacturing processes.

Referring to FIG. 9A, a shield 31a, an insulating layer 32, and a shield 31b are sequentially formed on a substrate (not shown). The shields 31a and 31b are formed of a generally used magnetic material, of the same material as that of the return pole P2. For example, NiFe can be used. For forming such a material, methods like a sputtering method, chemical vapor deposition (CVD), or atomic layer deposition (ALD) can be used. The insulating layer 32 is formed of an insulating material, such as, Al₂O₃, or SiO₂. A photoresist (PR) is formed in the upper portion of the shield 31b. Here, the photoresist defines the region in which the shield 31b is formed, and the distance between the photoresists may be about 500 nm or less and greater than a distance between the main pole P1 and the return pole P2.

Referring to FIG. 9B, the shield 31b between the photoresists (PR) is etched. Then, as illustrated in FIG. 9C, an insulating layer 33 is formed by coating an insulating material on the shield 31b and an etching region g₁. The insulating layer 33 may be formed of the same material as that of the insulting layer 32, and fills in the etching region g₁. In order to make the height of the insulating layer 33 uniform, chemical-mechanical planarizing (CMP) can be further conducted.

Referring to FIG. 9D, a shield 31c is formed on the insulating layer 33, and a photoresist is formed on the shield 31c and patterned. The photoresist in the center defines the shape of the main pole P1, and the distance between the photoresists may be about 500 nm or less and should be carefully controlled not to be smaller than the distance between the main pole P1 and the return pole P2, which will be formed later.

Referring to FIG. 9E, the shield 31c is etched in an open area between the photoresists to form the area of the shield 31c that is not etched in an etching region g₂ as a main pole P1. The shape of the main pole P1 may be various according to the etching method. Accordingly, the structure of the main pole P1 illustrated in FIG. 9E is not limited. Also, as illustrated in FIG. 9F, an insulating layer 34 is formed by coating an insulating material on the main pole P1, and the surface of the insulating layer 34 is planarized using CMP or the like.

Referring to FIG. 9G, a shield 31d is formed on the insulating layer 34, and as illustrated in FIG. 9H, a photoresist is coated and patterned. As illustrated in FIGS. 9H through 9J, a shield 31d in the open area of the photoresist is etched, and an insulating layer 35 is formed by etching the inside of an etching region g₃ with an insulating layer. CMP can be further conducted to planarize the surface of the insulating layer 35.

Finally, referring to FIG. 9K, a magnetic material is coated on the insulating layer 35 to form a return pole P2. Thus, a perpendicular magnetic head with a split structure according to an exemplary embodiment of the present invention can be provided.

While this invention has been particularly shown and described with reference to exemplary embodiments thereof, the exemplary embodiments should be considered in descriptive sense only and not for purposes of limitation. For example, the structure of the main pole P1 and the return pole P2 of the perpendicular magnetic head of the present invention can be modified from the structure illustrated in the drawings by those with ordinary skill in the art. Also, modification like forming more shields in a split structure is possible. Therefore, the scope of the invention is defined not by the detailed description of the invention but by the appended claims.

According to the present invention, the influence on the recording characteristic of the magnetic domain of the track of the neighboring recording layers in the cross track direction can be minimized. This is achieved by minimizing the leakage field and the leakage magnetic flux in the cross track direction, thereby minimizing ATE and WATE, and thus securing overall reliability of the recording medium.

What is claimed is:

1. A perpendicular magnetic head for recording a perpendicular magnetic recording medium, the perpendicular, magnetic head comprising:
a main pole;
a return pole, which has at least an end separated from the main pole; and
a plurality of shields that surround the main pole and have a split structure.

2. The perpendicular magnetic head of claim 1, wherein the shields are disposed at both sides of the main pole in the track direction and on the opposite side of the return pole of the main pole.

3. The perpendicular magnetic head of claim 1, wherein the shields are formed of NiFe.

4. The perpendicular magnetic head of claim 1, wherein a distance between the shields on both sides of the main pole is 500 nm or less.

5. The perpendicular magnetic head of claim 4, wherein a distance between the main pole and the shields is greater than a distance between the main pole and the return pole.

6. The perpendicular magnetic head of claim 1, wherein an insulating layer is formed between the main pole, the return pole, and the shields.

7. The perpendicular magnetic head of claim 6, wherein the insulating layer is formed of Al₂O₃ or SiO₂.

8. The perpendicular magnetic head of claim 1, wherein a surface of the shields adjacent to the main pole is an oval.

9. The perpendicular magnetic head of claim 1, wherein the end of the return pole is separated from the main pole at an air bearing surface.

10. A method of manufacturing a perpendicular magnetic head for recording a perpendicular magnetic recording medium, the method comprising:
(a) forming a first shield layer, a first insulating layer, and a second shield layer;
(b) etching a portion of the second shield layer, and sequentially forming a second insulating layer and a third shield layer on the remaining second shield layer and the first insulating layer;
(c) forming a main pole by etching the third shield layer and sequentially forming a third insulating layer and a fourth shield layer; and
(d) forming a fourth insulating layer by etching a portion corresponding to the main pole of the fourth shield layer, and forming a return pole on the fourth insulating layer.

11. The method of claim 10, wherein the first, second, third, and fourth shield layers are formed of NiFe.

12. The method of claim 10, wherein (b) comprises:
forming photoresist layers on the second shield layer at an interval of 500 nm or less; and
exposing the first insulating layer by etching the second shield layer exposed between the photoresist layers.

13. The method of claim 10, wherein (c) comprises:
forming patterned photoresist layers on the third shield layers;
forming the main pole by etching the third shield layer exposed by the photoresist layer; and
forming the third insulating layer by coating an insulating layer between the main pole and the third shield layer and on the main pole.

14. The method of claim 10, further comprising, after forming the second, third, and fourth insulating layers, planarizing the second, third, and fourth insulating layers using a CMP process.

15. The method of claim 10, wherein the insulating layer is formed of Al₂O₃ or SiO₂.
